(19) United States
(12) Patent Application Publication
(10) Pub. No.: US 2008/0061634 A1
(43) Pub. Date: Mar. 13, 2008

(54) Power-supply control device, interlock device, and electric apparatus

(75) Inventors: Atsuki Iwata, Tokyo (JP); Hiroshi Adachi, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/896,953

(22) Filed: Sep. 7, 2007

(30) Foreign Application Priority Data
Sep. 7, 2006 (JP) 2006-242963
Sep. 7, 2006 (JP) 2006-243081

(51) Int. Cl. H01H 7/00

(52) U.S. Cl. 307/141

(57) ABSTRACT

A power-supply control unit is connected in series on a power line between a power supply unit and an operating unit, and controls turning on/off of the power supply from the power supply unit to the operating unit. A resistor having a predetermined resistance is connected in series with the power-supply control unit. A switch unit is connected in parallel with the resistor. A switch control unit detects turning on of the power supply from the power supply unit to the operating unit by the power-supply control unit, and turns on the switch unit in a predetermined waiting time after detecting the turning on of the power supply.

### CROSS-REFERENCE TO RELATED APPLICATIONS

The present application claims priority to and incorporates by reference the entire contents of Japanese priority documents, 2006-242963 filed in Japan on Sep. 7, 2006 and 2006-243081 filed in Japan on Sep. 7, 2006.

### BACKGROUND OF THE INVENTION

1. Field of the Invention

The present invention relates to a power-supply control device, an interlock device, and an electric apparatus.

2. Description of the Related Art

In a typical electric apparatus, such as an image forming apparatus and an image reading apparatus, a switch is provided between a power supply unit and an operating unit to which a power is supplied from the power supply unit. When the switch is turned on, the power is supplied to the operating unit from the power supply unit, so that the electric apparatus is activated. However, at the instant of turning on the switch, an excessive inrush current flows into the operating unit, which may damage the operating unit, generate noise, or lead to other serious problems.

Particularly, an electric apparatus, such as an image forming apparatus (e.g., a facsimile, a copier, and a printer), which has a load to which a high voltage is applied or a load that generates a heat, includes an interlock device. The interlock device controls a power supplied to the load by a mechanical operation, such as a cover opening/closing operation, for preventing a user from an electrical shock or a burn. Generally, the interlock device is classified into two types: one including an interlock switch that is provided in series between the power supply unit and the load, and that is triggered by the mechanical operation of the electric apparatus; the other including a relay that turns on/off a power supplied to a relay coil being triggered by the mechanical operation of an electric apparatus, and that has a relay contact connected in series between the power supply unit and the load.

In such interlock devices, at the instant of closing the interlock switch or the relay contact, an inrush current flows in a current line. In a conventional electric apparatus shown in FIG. 13, a switch (interlock switch) 103, such as a microswitch, is provided between a power supply unit 101 and a load 102, and a power is supplied from the power supply unit 101 to the load 102 when the switch 103 is turned on. The load 102 includes a load resistance component 102R and a load capacitance component 102C. The power charged in the load capacitance component 102C is discharged while the power is turned off. At the instant of turning on the switch 103, a large charging current, i.e., an inrush current, directly flows into the load capacitance component 102C through the switch 103. In electric apparatuses such as an image forming apparatus, the inrush current sometimes reaches over 100 ampere (A) depending on conditions of voltage, circuit parts, and the like. Thus, durability of circuit parts and a switch and selection of the load capacitance component in designing a circuit are important factors.

To limit the inrush current, Japanese Patent Application Laid-open No. 2005-354855 discloses an inrush current limiting circuit that includes a transistor, an operating circuit, and a base control circuit. An emitter of the transistor is connected to an output side of a power supply unit, and a collector of the transistor is connected to an input side of a load circuit. The operating circuit is connected between the output side of the power supply unit and the base of the transistor. With turning the power supply unit on by a switch, the operating circuit supplies a base current to a base of the transistor. The base circuit is connected to the base of the transistor and controls the base current. The inrush current circuit including the transistor is provided between the power supply unit and the load circuit, and the transistor controls a current flowing into the load circuit when the power supply unit is turned on.

A direct current (DC) relay is disclosed in Japanese Patent Application Lain-open No. 2005-19107. The DC relay includes a noncontact switch that is provided between a power supply unit and a load and that is capable of interrupting a power supplied to the load, and a disconnection unit that is capable of mechanically disconnecting the load from the power supply unit. The noncontact switch is connected in parallel with a resistor, and the inrush current is limited by the resistor. The noncontact switch is turned on after a predetermined time, so that an appropriate power is supplied to the load.

However, with the above conventional technologies, an improvement is still needed in limiting the inrush current properly at low cost, and supplying a power appropriately to an operating unit.

In the technology disclosed in Japanese Patent Application Laid-open No. 2005-354855, because the switch turns on/off the power supply unit, and the inrush current control circuit including the transistor controls a current output from the power supply unit, the inrush current control circuit needs to be provided in addition to the switch, which increases the cost. In addition, because the base current in the transistor is controlled by the resistor to limit the inrush current to the load and to control a steady current output to the load, the steady current is affected by the internal resistance of the transistor.

In the technology disclosed in Japanese Patent Application Laid-open No. 2005-19107, a current is appropriately supplied to the load in the steady state by connecting the noncontact switch in series with the mechanical disconnection unit and in parallel with the resistor, limiting the inrush current caused when the power is on by the resistor, and then turning on the noncontact switch. However, because it is hard to get a right timing for turning on the noncontact switch, the circuit becomes complex in configuration and expensive to compensate for the timing error. Therefore, an improvement is needed in properly supplying the steady current at the right timing to the load after the inrush current is limited.

### SUMMARY OF THE INVENTION

It is an object of the present invention to at least partially solve the problems in the conventional technology.

A power-supply control device according to one aspect of the present invention controls a power supply from a power supply unit to an operating unit. The power-supply control device includes a power-supply control unit that is connected in series on a power line between the power supply unit and the operating unit, and that controls turning on/off of the power supply from the power supply unit to the operating unit; a resistor having a predetermined resistance connected in series with the power-supply control unit; a switch unit connected in parallel with the resistor; and a switch control unit that detects turning on of the power supply from the power supply unit to the operating unit by the power-supply control unit, and turns on the switch unit in a predetermined waiting time after detecting the turning on of the power supply.

An electric apparatus according to another aspect of the present invention includes a power supply unit that supplies a power; an operating unit to which the power is supplied from the power supply unit; and the power-supply control device according to the present invention arranged between the power supply unit and the operating unit.

An interlock device for an electric apparatus according to still another aspect of the present invention includes an interlock switch that performs on/off operation in conjunction with a predetermined mechanical operation of the electric apparatus to control turning on/off of a power supply from a power supply unit to an operating unit; a resistor having a predetermined resistance connected in series with the interlock switch; a switch unit connected in parallel with the resistor; and a switch control unit that detects turning on of the power supply from the power supply unit to the operating unit by the interlock switch, and turns on the switch unit in a predetermined waiting time after detecting the turning on of the power supply.

An electric apparatus according to still another aspect of the present invention includes a power supply unit that supplies a power; an operating unit to which the power is supplied from the power supply unit; and the interlock device according to the present invention arranged between the power supply unit and the operating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an interlock device of Example 1 according to a first embodiment of the present invention;

FIG. 2 is a block diagram of an interlock device that is different in arrangement of components from the interlock device shown in FIG. 1;

FIG. 3 is a circuit diagram of the interlock device shown in FIG. 1;

FIG. 4 is a graph of time-dependent current and voltage obtained when the interlock device shown in FIG. 3 is turned on, comparing with a conventional example;

FIG. 5 is a circuit diagram of an interlock device of Example 2 according to the first embodiment;

FIG. 6 is a circuit diagram of another example of the interlock device shown in FIG. 3;

FIG. 7 is a block diagram of a relevant portion of an image forming apparatus of Example 3 according to the first embodiment;

FIG. 8 is a circuit block diagram of an interlock device of Example 1 according to a second embodiment of the present invention;

FIG. 9 is a circuit diagram of the interlock device shown in FIG. 8;

FIG. 10 is a circuit diagram of an interlock device of Example 2 according to the second embodiment;

FIG. 11 is a circuit diagram of another example of the interlock device shown in FIG. 10;

FIG. 12 is a block diagram of a relevant portion of an image forming apparatus of Example 3 according to the second embodiment; and

FIG. 13 is a circuit block diagram of a power supply system in a conventional electric apparatus.

### DETAILED DESCRIPTION OF THE PREFERRED EMBODIMENTS

Exemplary embodiments of the present invention are explained in detail below with reference to the accompanying drawings.

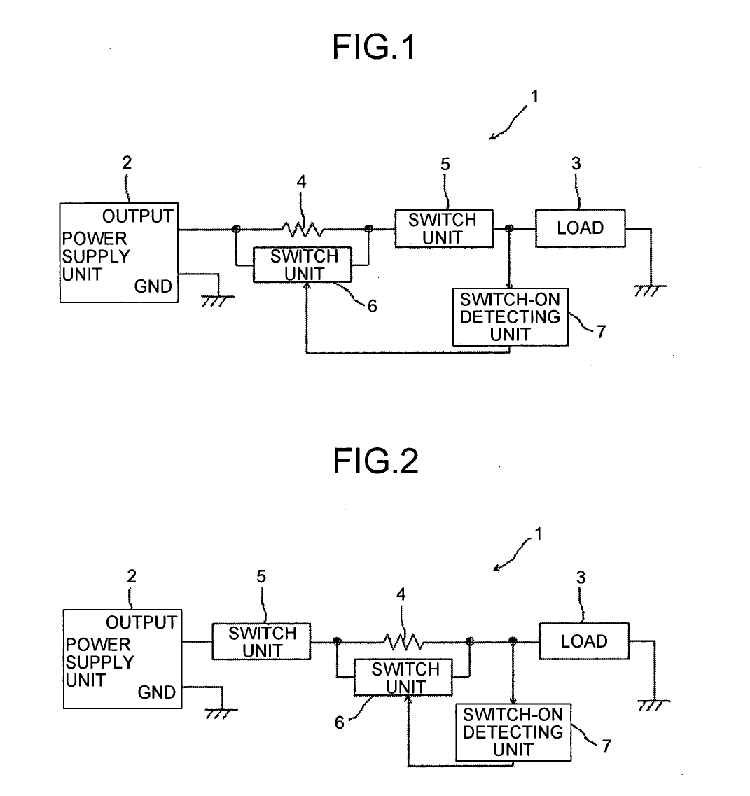

An interlock device 1 in Example 1 according to a first embodiment of the present invention is explained below with reference to FIGS. 1 to 4. FIG. 1 is a circuit block diagram of the interlock device 1 in Example 1.

The interlock device 1 is connected between a power supply unit 2 and a load 3 that is an operating unit. The interlock device 1 includes a resistor 4 and a switch unit (power supply control unit, or interlock switch) 5 that are connected in series in a power line between the power supply unit 2 and the load 3, a switch unit 6 that is connected in parallel with the resistor 4, and a switch-on detecting unit 7. Typically, the load 3 is grounded. When the switch unit 5 of the interlock device 1 is on in the steady state, a steady current flows from the power supply unit 2 into the load 3 through the switch unit 6 and the switch unit 5, thereby supplying a power to the load 3.

In the interlock device 1 shown in FIG. 1, the resistor 4 is connected to the power supply unit 2 side, and the switch unit 5 is connected to the load 3 side. However, the connection arrangement is not limited to the above order. Namely, the switch unit 5 can be connected to the power supply unit 2 side and the resistor 4 can be connected to the load 3 side as shown in FIG. 2.

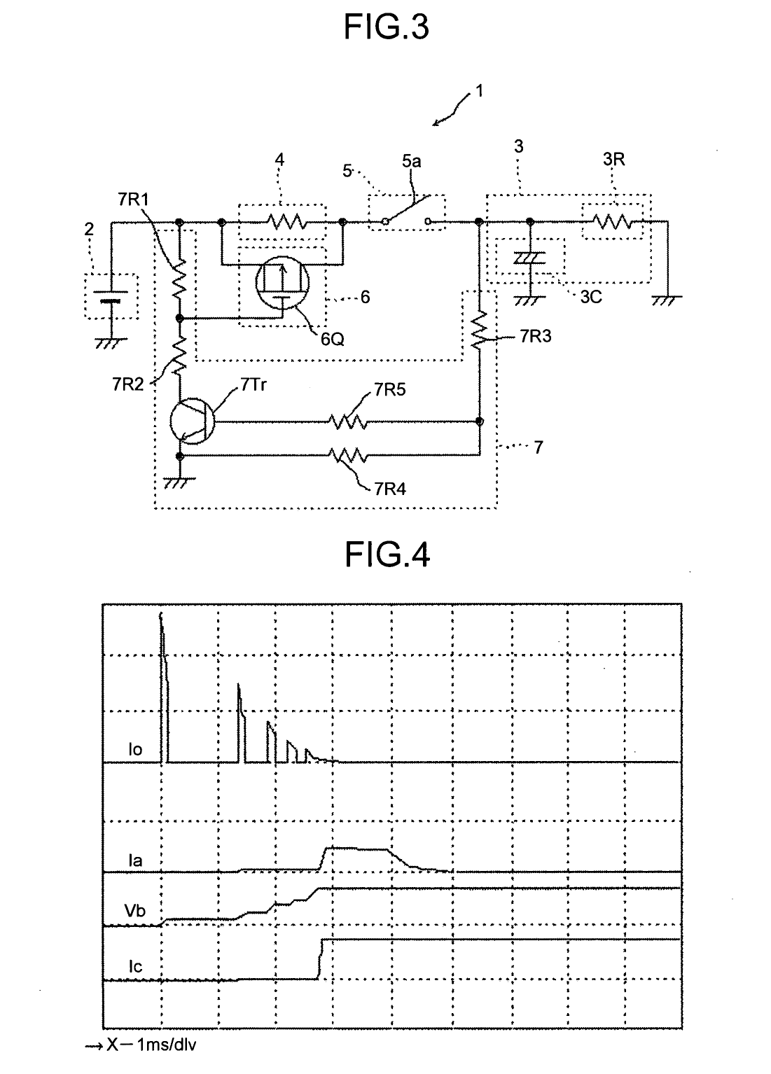

The interlock device 1 shown in FIG. 1 has a circuit configuration shown in FIG. 3. FIG. 3 represents the case where a DC power supply is used as the power supply unit 2. A microswitch unit 5a is used in the switch unit 5, and the load 3 includes a load resistance component 3R and a load capacitance component 3C. The resistor 4 has a predetermined resistance appropriate for limiting an inrush current generated at the start of power supply.

A field effect transistor (FET) 6Q is used in the switch unit 6. The switch-on detecting unit 7 includes a common-emitter NPN transistor 7Tr and resistors 7R1 to 7R5. The FET 6Q is connected in parallel with the resistor 4. A drain of the FET 6Q is connected to the switch unit 5 side, and a source of the FET 6Q is connected to the power supply unit 2 side. The resistor 7R1 is connected between the gate and the source of the FET 6Q. The FET 6Q is connected to the collector of the common-emitter transistor 7Tr through the resistor 7R2.

The base of the transistor 7Tr is connected to a contact point between the switch unit 5 and the load 3 through the resistor 7R5 and a resistor 7R3, which are connected in series. A contact point between the resistor 7R3 and the resistor 7R5 is connected through the resistor 7R4 to the emitter that is grounded. Therefore, the resistor 7R3 and the resistor 7R4 serve as voltage dividing resistors and divide the voltage supplied to the load 3 in proportion to their resistances, and a divided voltage is supplied to the base of the transistor 7Tr through the resistor 7R5. When the divided voltage, which is supplied to the transistor 7Tr, reaches the turn-on voltage of the transistor 7Tr, the transistor 7Tr is turned on.

The switch-on detecting unit 7 appropriately sets the circuit constants, particularly, resistances of the resistor 7R3, the resistor 7R4, and the resistor 7R1, while taking the capacity of the load capacitance component 3C of the load 3 into account. Whereby, the switch-on detecting unit 7 can set an appropriate waiting time from the turn-on of the microswitch unit 5a to the turn-on of the FET 6Q. The switch-on detecting unit 7 turns on the FET 6Q after the waiting time passes. Hence, as described below, the inrush current generated just after the microswitch unit 5a is turned on can be limited properly, and a current to be supplied in the steady state can be appropriate.

The interlock device 1 limits the inrush current, which is generated just after the switch unit 5 is turned on, by the resistor 4. Thereafter, the interlock device 1 allows the switch unit 6 to be turned on after a predetermined waiting time passes, whereby a proper steady current can be supplied to the load 3.

Specifically, in the interlock device 1 in the steady state, while the microswitch unit 5a is closed, the FET 6Q is turned on, and the steady current is supplied to the load 3 from the power supply unit 2 through the FET 6Q and the microswitch unit 5a.

In the steady state, an input of the divided voltage, which is obtained by the resistor 7R3 and the resistor 7R4, to the base of the transistor 7Tr turns on the transistor 7Tr, resulting in the divided voltage obtained by the resistor 7R1 and the resistor 7R2 to reach a level to allow the gate-drain voltage to turn on the FET 6Q.

Accordingly, a power is supplied from the power supply unit 2 to the load 3 through the FET 6Q and the microswitch unit 5a, so that an appropriate steady current is supplied to the load 3.

When an opening and closing unit of the electric apparatus is opened in the steady state, the microswitch unit 5a of the switch unit 5 is turned off (open), so that the supply of the steady current from the power supply unit 2 to the load 3 is interrupted. Therefore, the electric apparatus is turned off. Once the microswitch unit 5a is turned off, the base voltage of the transistor 7Tr declines, which causes the transistor 7Tr to be turned off. Thus, the gate-drain voltage of the FET 6Q declines, and the FET 6Q is turned off.

In the power-off state, when the opening and closing unit is closed, the interlock device 1 turns on (close) the microswitch unit 5a, and thereby a power is supplied from the power supply unit 2 to the load 3 through the resistor 4 and the microswitch unit 5a. Because the power is supplied to the load 3 through the resistor 4, an excessive inrush current to the load 3 can be appropriately limited.

When the microswitch unit 5a is turned on, and the power starts to be supplied from the power supply unit 2 to the load 3 through the resistor 4, charging of the load capacitance component 3C of the load 3 is started. With the charging of the load capacitance component 3C, the divided voltage, which is obtained by the resistor 7R3 and the resistor 7R4, is input to the base of the transistor 7Tr increases. When a predetermined waiting time set based on the circuit constants passes, the transistor 7Tr is turned on. Furthermore, when the divided voltage obtained by the resistor 7R1 and the resistor 7R2 reaches a level sufficient to allow the gate-drain voltage to turn on the FET 6Q, the FET 6Q is turned on.

When the FET 6Q is turned on, the power, which is supplied from the power supply unit 2 to the load 3 through the resistor 4, starts to be supplied to the load 3 through the FET 6Q. Thus, an appropriate steady current can be stably supplied to the load 3.

A circuit including the interlock device 1 shown in FIG. 3 is made by simulation under the following conditions. That is, the load capacitance component 3C of the load 3 has a capacity of 13 mF, the load resistance component 3R has a resistance of 10 kΩ, and the power supply unit 2 has a DC voltage of 24 V. In the interlock device 1, the circuit constants are set such that the resistor 4 has a resistance of 10 kΩ, and the resistors 7R1 to 7R5 each have a resistance of 10 kΩ. In the above conditions, a current supplied from the power supply unit 2 to the load 3 is calculated when the microswitch unit 5a is turned on. The result of the calculation is represented in FIG. 4. The scale of the base-emitter voltage is 1 V/div, and the scale of the gate-source voltage of the FET 6Q is 15 V/div. In the simulation, a SCAT manufactured by KEISOKU GIKEN Co., Ltd is used as a simulation tool.

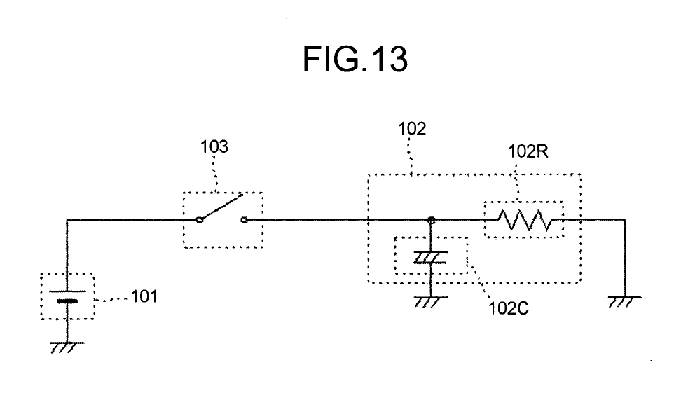

In FIG. 4, Io represents the current that flows into the load 102 at the time of power-on of the conventional electric apparatus shown in FIG. 13, Ia represents the current that flows into the microswitch unit 5a shown in FIG. 3, Vb represents the base voltage of the transistor 7Tr, and Ic represents the current that flows into the FET 6Q.

FIG. 4 indicates that a large inrush current is generated in the conventional electric apparatus shown in FIG. 13, while the interlock device 1 shown in FIG. 3, with a simple configuration at low cost, can appropriately limit the inrush current and stably supply an appropriate steady current after a waiting time passes. Taking into account the actual switching operation, FIG. 4 represents the currents and the voltage generated when chattering of the switch unit 5 and the switch 103 occurs.

In the interlock device 1, the resistor 4 is connected in series with the microswitch unit 5a, and the FET 6Q is connected in parallel with the resistor 4. The microswitch unit 5a performs on/off action being triggered by a predetermined mechanical operation of, for example, the opening and closing unit of the electric apparatus, thereby turning on/off the power supply from the power supply unit 2 to the load 3. The switch-on detecting unit 7 detects turning on of the microswitch unit 5a, and turns on the FET 6Q after a predetermined waiting time passes.

Accordingly, it is possible to realize the interlock device with a simple configuration at low cost, which can limit an excessive inrush current generated at the start of power supply and can supply an appropriate power to the load 3 in the steady state by turning on the FET 6Q at the right timing.

The interlock device 1 includes the microswitch unit 5a in the switch unit 5. Thus, it is possible to realize the interlock device with a simpler configuration at a lower cost, which can limit an excessive inrush current generated at the start of the power supply and can supply an appropriate power in the steady state.

The switch-on detecting unit 7 of the interlock device 1 includes the voltage dividing resistors (resistor 7R3 and resistor 7R4) and the transistor 7Tr. The resistor 7R3 and resistor 7R4 divide the voltage supplied to the load 3 through the microswitch unit 5a and the resistor 4, and the transistor 7Tr is turned on/off based on the divided voltage. By turning on the transistor 7Tr, the switch unit 6 is turned on.

Accordingly, with a simple circuit configuration, the switch-on detecting unit 7 can appropriately and precisely detect the turning on of the switch unit 5 and turn on the switch unit 6 at the right timing. Therefore, an excessive inrush current generated at the start of the power supply can be appropriately limited, and the load 3 can be supplied with an appropriate power in the steady state by turning on the FET 6Q at the right timing at a lower cost.

The switch-on detecting unit 7 decides the waiting time according to the resistances of the voltage dividing resistors, i.e., the resistor 7R3 and the resistor 7R4. Therefore, with a simple circuit configuration, the switch-on detecting unit 7 can turn on the switch unit 6 at the right timing by appropriately and precisely detecting the turning on of the switch unit 5. Thus, an excessive inrush current generated at the start of the power supply can be appropriately limited, and the load 3 can be supplied with an appropriate power in the steady state by turning on the FET 6Q at the right timing at a lower cost.

In Example 1 according to the first embodiment, the load 3 is grounded, and a current always flows into the load resistance component 3R of the load 3 through the FET 6Q when the switch unit 5 is on in the steady state. Alternatively, it is possible to control on/off of the current flowing into the load resistance component 3R when the switch unit 5 is on (e.g., by having a circuit configuration in which the load 3 is not directly grounded).

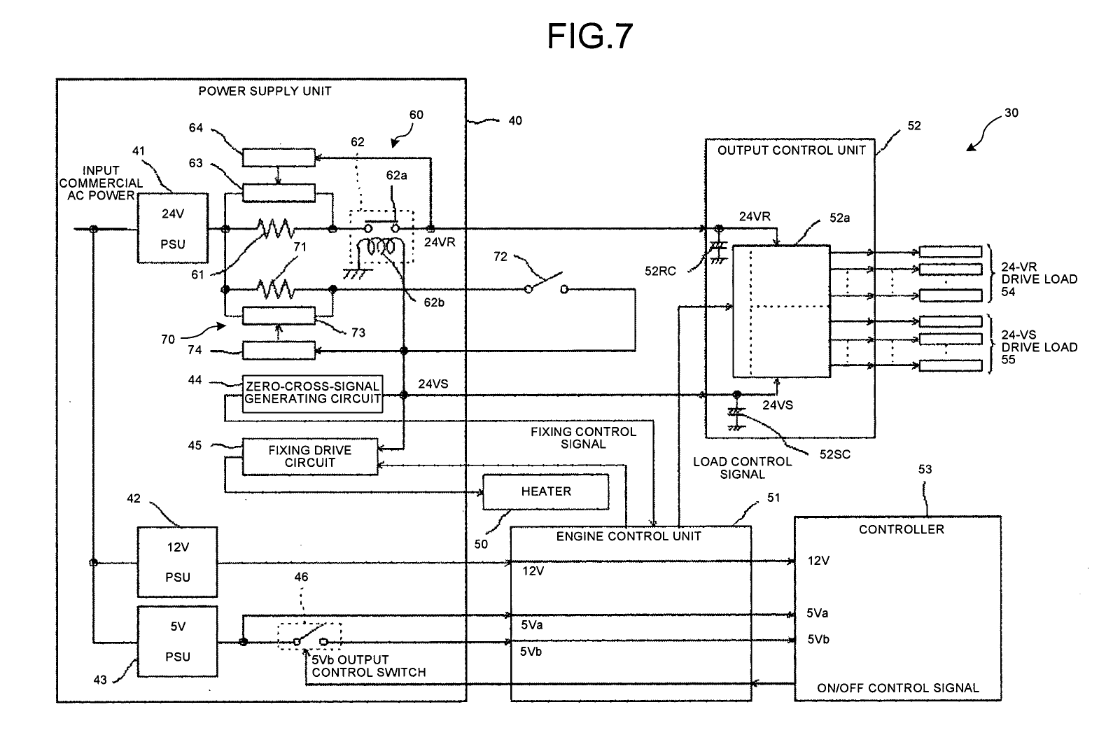

A representative example of such a load is an output control unit 52 shown in FIG. 7, which is described below. Normally, an electric apparatus or an image forming apparatus including the output control unit employs a system in which a current flowing into a drive load of the output control unit (hereinafter, “drive load current”) is controlled to flow when it is confirmed that the switch unit 5 is on. Accordingly, with such a load, when the drive load current is off, the load resistance component 3R has extremely large resistance, so that a current hardly flows into the load resistance component 3R. In other words, a charging current flows only into the load capacitance component 3C until the drive load current is controlled to be on after the switch unit 5 is turned on. When the load capacitance component 3C is in a fully-charged state, a current hardly flows into the load 3.

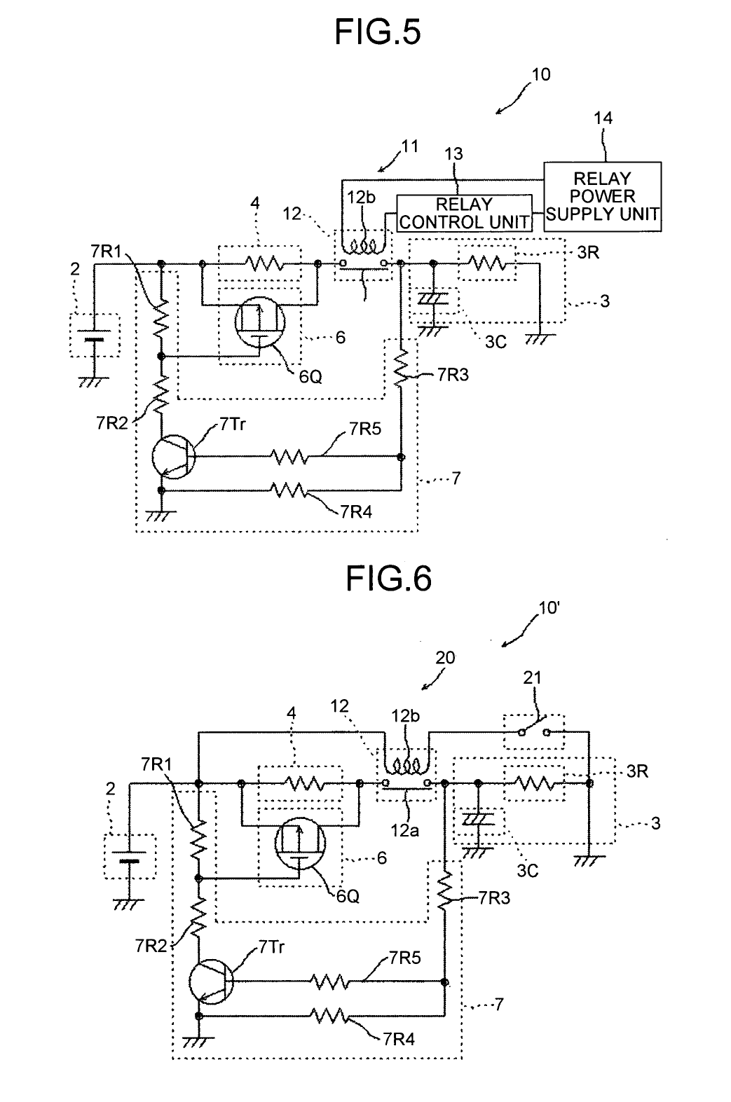

FIG. 5 is a circuit diagram of an interlock device 10 in Example 2.

In Example 2, the components same as those of the interlock device 1 in Example 1 are given the same reference numerals, and the detailed explanation thereof is omitted.

The interlock device 10 is connected between the power supply unit 2 and the load 3 that is an operating unit. The interlock device 10 includes the resistor 4 and a switch unit 11 that are connected in series in a power line between the power supply unit 2 and the load 3, the switch unit 6 that is connected in parallel with the resistor 4, and the switch-on detecting unit 7. Typically, the load 3 is grounded. When the switch unit 11 of the interlock device 10 is on in the steady state, the steady current flows from the power supply unit 2 into the load 3 through the switch unit 6 and the switch unit 5, thereby supplying a power to the load 3.

The switch unit 11 includes a relay 12, a relay control unit 13, and a relay power supply unit 14. The relay 12 includes a relay contact 12a and a drive coil 12b. The relay contact 12a is connected in series with the resistor 4 in the power line between the power supply unit 2 and the load 3, and opens and closes the power line. The drive coil 12b drives the relay contact 12a to open and close the power line. The drive coil 12b is directly connected at one end to the relay power supply unit 14, and the other end thereof is connected to the relay power supply unit 14 through the relay control unit 13.

For example, when a sensor (not shown) detects an open/close operation of a door or a cover of a sheet discharge tray of an electric apparatus, or when a controller (not shown) detects power on/off of the electric apparatus, the sensor or the controller sends a detection signal to the relay control unit 13. The relay control unit 13 receives the detection signal, and then controls supply/stop of the drive current to the drive coil 12b of the relay 12 from the relay power supply unit 14 according to the detection signal. The relay control unit 13 keeps the relay contact 12a turned on (close) while supplying the drive current to the drive coil 12b, so that the steady current is supplied to the load 3 from the power supply unit 2. Whereas, the relay control unit 13 keeps the relay contact 12a turned off (open) while stopping the supply of the drive current to the drive coil 12b, so that the steady current stops being supplied to the load 3 from the power supply unit 2.

In a similar manner to Example 1, the resistor 4 has a predetermined resistance. Hence, when the relay contact 12a is turned on and the power supply is started, the inrush current flowing into the load 3 can be properly limited.

The interlock device 10 limits the inrush current generated just after the switch unit 11 is turned on, by the resistor 4. Thereafter, the interlock device 10 allows the switch unit 6 to be turned on after a predetermined time passes, so that the steady current is supplied properly to the load 3.

Specifically, in the steady state, in the interlock device 10, the relay control unit 13 of the switch unit 11 allows the drive current to flow from the relay power supply unit 14 into the drive coil 12b, closes the relay contact 12a, and turns on the FET 6Q. Therefore, the steady current is supplied to the load 3 from the power supply unit 2 through the FET 6Q and the relay 12.

In the steady state, both ends of the resistor 4 are short-circuited by the FET 6Q of the switch unit 6, so that a desired steady current can be stably supplied to the load 3.

In the steady state, when the relay control unit 13 receives a signal from the sensor indicating that the opening and closing unit is opened, or a power-off signal from the controller, the relay control unit 13 causes the relay power supply unit 14 to stop the supply of the drive current to the drive coil 12b. Therefore, the relay contact 12a is turned off, so that the supply of the steady current from the power supply unit 2 to the load 3 is interrupted. Thus, the electric apparatus becomes in the power-off state.

In the power-off state, when the relay control unit 13 receives a signal from the sensor indicating that the opening and closing unit is closed, or a power-on signal from the controller, the relay control unit 13 causes the relay power supply unit 14 to supply the drive current to the drive coil 12b. Therefore, the relay contact 12a is turned on, and a power is supplied to the load 3 from the power supply unit 2 through the resistor 4 and the relay contact 12a. When the power starts to be supplied to the load 3 from the power supply unit 2 through the resistor 4, charging of the load capacitance component 3C is started. With the charging of the load capacitance component 3C, the divided voltage, which is obtained by the resistor 7R3 and the resistor 7R4 and is input to the base of the transistor 7Tr, increases. When a predetermined waiting time set based on the circuit constants passes, the transistor 7Tr is turned on, and the divided voltage obtained by the resistor 7R1 and the resistor 7R2 reaches a level sufficient to allow the gate-drain voltage to turn on the FET 6Q.

When the FET 6Q is turned on, the power, which is supplied from the power supply unit 2 to the load 3 through the resistor 4, starts to be supplied to the load 3 through the FET 6Q. Thus, an appropriate steady current can be stably supplied to the load 3.

The interlock device 10 includes the relay 12 as the interlock switch. Therefore, it is possible to realize the interlock device with a simple configuration at low cost, which can limit an excessive inrush current generated at the start of the power supply by the resistor 4 and can supply an appropriate power to the load 3 in the steady state by turning on the FET 6Q at the right timing.

In Example 2, the switch unit 11 includes the relay power supply unit 14 as a dedicated power supply unit for driving the relay 12. However, the switch unit 11 may not include a dedicated power supply unit for driving the relay 12. Instead, as shown in FIG. 6, the drive coil 12b can be connected to the power supply unit 2, and a switch 20 can utilize the power supply unit 2 for driving the relay 12.

FIG. 6 represents the case where a microswitch 21 of the switch 20 in an interlock device 10′ provided to the opening and closing unit of the electric apparatus to serves as the relay control unit 13 in FIG. 5. When the opening and closing unit is closed, the microswitch 21 of the interlock device 10′ shown in FIG. 6 is closed (turned on), and the drive current flows from the power supply unit 2 into the drive coil 12b, so that the relay contact 12a is turned on. Whereby, the steady current flows from the power supply unit 2 into the load 3. When the opening and closing unit is opened, the microswitch 21 is opened (turned off), and the drive current is interrupted from flowing into the drive coil 12b, so that the relay contact 12a is turned off.

The interlock device 10′ does not include a dedicated power supply unit and a capacitive load in the switch 20. Therefore, no large inrush current flows into the drive coil 12b at the instant of turning the microswitch 21. Thus, parts with a low current rating can be used as the microswitch 21, so that the interlock device can be small in size and be manufactured at low cost.

FIG. 7 is a block diagram of a relevant portion of an image forming apparatus (electric apparatus) 30 of Example 3 according to the first embodiment. The image forming apparatus 30 includes a power supply unit 40, a heater (fixing heater) 50, an engine control unit 51, the output control unit 52, a controller 53, a 24-VR drive load 54, a 24-VS drive load 55, an interlock device 60, and an interlock device 70.

The power supply unit 40 includes PSUs (Power Supply Units) 41 to 43 for supplying voltages of 24 V, 12 V, and 5 V, respectively, a zero-cross-signal generating circuit 44, a fixing drive circuit 45, and a 5-Vb output control switch 46. In addition, the power supply unit 40 includes a resistor 61, a relay 62, a switch unit 63, and a switch-on detecting unit 64 of the interlock device 60, and a resistor 71, a switch 73, and a switch-on detecting unit 74 of the interlock device 70.

A 100-V commercial alternating current (AC) power is input to each of the PSUs 41 to 43. The PSU 41 converts the 100-V commercial AC power into a 24-V DC power. Then, the PSU 41 supplies the 24-V DC power (24-VR power) to the output control unit 52 through the interlock device 60, and supplies the 24-V DC power (24-VS power) to the output control unit 52 through the interlock device 70. In addition, the PSU 41 supplies the 24-V DC power (24-VS power) to the zero-cross-signal generating circuit 44 and the fixing drive circuit 45.

The PSU 42 converts the 100-V commercial AC power into a 12-V DC power, and supplies the 12-V DC power to the engine control unit 51. The PSU 43 converts the 100-V commercial AC power into a 5-V DC power, and supplies the 5-V DC power (5-Va power) directly to a 5-Va terminal of the engine control unit 51, and supplies the 5-V DC power (5-Vb power) to a 5-Vb terminal of the engine control unit 51 through the 5-Vb output control switch 46.

The engine control unit 51 outputs the 12-V DC power that is output from the PSU 42, to the controller 53. The controller 53 uses the 12-V DC power mainly as a drive power for a hard disk. In addition, the engine control unit 51 further outputs the 5-Va power and the 5-Vb power, which are output from the PSU 43, to the controller 53. The controller 53 judges whether the 5-Vb output is necessary for a system. Specifically, the controller 53 judges that the 5-Vb output is necessary when the system is on standby or in operation, and that 5-Vb output is not necessary when the system is in the power-off mode or in the sleep mode. After the judgment, the controller 53 outputs the on/off control signal for the 5-Vb output to the engine control unit 51. The engine control unit 51 receives the on/off control signal and outputs the on/off control signal to the 5-Vb output control switch 46, thereby controlling on/off of the 5-Vb output control switch 46.

The interlock device 60 includes the resistor 61, the relay (power-supply control unit) 62, the switch unit 63 that is connected in parallel with the resistor 61, and the switch-on detecting unit 64. A relay contact 62a of the relay 62 is connected in series between the resistor 61 and the output control unit 52. A drive coil 62b of the relay 62 is grounded at one end, and is connected to the PSU 41 through a microswitch (power-supply control unit, or interlock) 72 and the resistor 71 at the other end.

The resistor 71 and the microswitch 72 are connected in series in the interlock device 70. The microswitch 72 is provided to the opening and closing unit, such as a door or a sheet discharge tray, of the image forming apparatus 30. When the opening and closing unit is mechanically opened, the microswitch 72 is turned off (open). When the opening and closing unit is mechanically closed, the microswitch 72 is turned on (close). The switch 73 is connected in parallel with the resistor 71. The switch 73 and the switch-on detecting unit 74 have configurations similar to those of the switch unit 6 and the switch-on detecting unit 7 in Example 1, respectively. The switch-on detecting unit 74 detects on/off of the microswitch 72, and controls on/off of the switch 73.

Specifically, when the opening and closing unit of the image forming apparatus 30 is closed and the microswitch 72 is turned on, a current by the 24-V DC power from the PSU 41 is supplied to the zero-cross-signal generating circuit 44 and the fixing drive circuit 45 through the resistor 71 of the interlock device 70, and the drive current flows into the drive coil 62b of the interlock device 60.

Upon the flowing of the drive current into the drive coil 62b, the relay contact 62a is turned on (close), so that the PSU 41 is connected to the output control unit 52 through the resistor 61. Whereby, a current by the 24-V DC power from the PSU 41 is supplied to the output control unit 52 through the resistor 61 as the 24-VR power.

When the microswitch 72 is turned on, the switch-on detecting unit 74 detects the on-action of the microswitch 72, and turns on the switch 73 after a predetermined waiting time passes. Once the switch 73 is turned on, the steady current by the 24-V DC power from the PSU 41 is supplied to the zero-cross-signal generating circuit 44 and the fixing drive circuit 45 through the switch 73 and the microswitch 72.

When the relay 62 is turned on, the switch-on detecting unit 64 detects the on-action of the relay 62, and turns on the switch unit 63 after a predetermined waiting time passes. Once the switch unit 63 is turned on, the steady current by the 24-V DC power from the PSU 41 is supplied to the output control unit 52 through the switch unit 63.

The zero-cross-signal generating circuit 44 outputs a zero cross signal to the engine control unit 51, and the engine control unit 51 recognizes a zero cross timing based on the zero cross signal and a turning-on condition of the heater in a fixing unit (not shown), and outputs the fixing control signal to the fixing drive circuit 45.

The fixing drive circuit 45 controls the drive current output to the heater 50 based on the zero cross signal output from the zero-cross-signal generating circuit 44 and the fixing control signal from the engine control unit 51, and controls heating by the heater 50. The heater 50 heats a heating roller (not shown) of the fixing unit. The heating roller heats and pressurizes a paper sheet being conveyed and having a toner image transferred thereon in the electrophotographic system, thereby fixing the toner image onto the paper sheet.

The output control unit 52 includes a load control block unit 52a to which the 24-VS power and the 24-VR power are output from the PSU 41. The load control block unit 52a includes capacitive components as a load, and the input units, to which the 24-VS power and the 24-VR power are input, are respectively connected to a load capacitance component 52SC and a load capacitance component 52RC. A load control signal is input to the load control block unit 52a from the engine control unit 51. Based on the load control signal, a current flowing into the 24-VR drive load 54 and the 24-VS drive load 55 is controlled. The 24-VR drive load 54 is driven by the 24-VR power, and the 24-VS drive load 55 is driven by the 24-VS power.

In the image forming apparatus 30, when the relay contact 62a is on, the PSU 41 supplies the 24-VR power in the steady state to the output control unit 52 through the relay contact 62a. When the microswitch 72 is on, the PSU 41 supplies the 24-VS power in the steady state to the output control unit 52 through the microswitch 72, and also to the zero-cross-signal generating circuit 44 and the fixing drive circuit 45.

In the steady state, when the opening and closing unit of the image forming apparatus 30 is opened, the microswitch 72 is turned off. This stops supplying of the 24-VS power to the output control unit 52, the zero-cross-signal generating circuit 44, and the fixing drive circuit 45. Whereby, the drive current being supplied to the drive coil 62b is stopped.

When the supplying of the drive current to the drive coil 62b is stopped, the relay 62 is turned off (open), and the PSU 41 stops the supplying of the 24-VR power to the output control unit 52. Whereby, the image forming apparatus 30 becomes in the power-off state.

In the power-off state, when the opening and closing unit is closed, the microswitch 72 is turned on. Then, the PSU 41 starts to supply the 24-VS power in the steady state to the output control unit 52 through the microswitch 72, and supply the 24-VS power in the steady state to the zero-cross-signal generating circuit 44 and the fixing drive circuit 45.

Because the current, which is to be supplied to the output control unit 52, flows through the resistor 71 of the interlock device 70, an excessive inrush current can be limited.

Furthermore, when the microswitch 72 is turned on, the drive current flows into the drive coil 62b, and the relay contact 62a is turned on. Then, the PSU 41 starts to supply the 24-VR power to the output control unit 52.

Because the current, which is to be supplied to the output control unit 52 when the relay 62 is turned on, flows through the resistor 61 of the interlock device 60, an excessive inrush current can be limited.

When the microswitch 72 is turned on, the switch-on detecting unit 74 detects the on-action of the microswitch 72, and turns on the switch 73 after a predetermined waiting time passes. After the switch 73 is turned on, the steady current, which is generated by the 24-V DC power from the PSU 41, is supplied to the zero-cross-signal generating circuit 44 and the fixing drive circuit 45 through the switch 73 and the microswitch 72. When the relay 62 is turned on, the switch-on detecting unit 64 detects the on-action of the relay 62, and turns on the switch unit 63 after a predetermined waiting time passes. After the switch unit 63 is turned on, the steady current, which is generated by the 24-V DC power from the PSU 41, is supplied to the output control unit 52. Accordingly, the appropriate steady current can be supplied to the output control unit 52 at the right timing.

In the image forming apparatus 30, the interlock device 60 and the interlock device 70 are provided between the PSU 41 and the load control block unit 52a (output control unit 52). Therefore, with a simple configuration at low cost, an excessive inrush current generated at the time of starting the power supply can be properly limited by the resistor 4, and the load 3 can be supplied with an appropriate power in the steady state by turning on the FET 6Q at the right timing.

This embodiment is explained by employing the image forming apparatus 30, such as a facsimile, a complex machine, and a printer. However, any electric apparatus that may cause an inrush current by turning on/off the power supply unit can be employed.

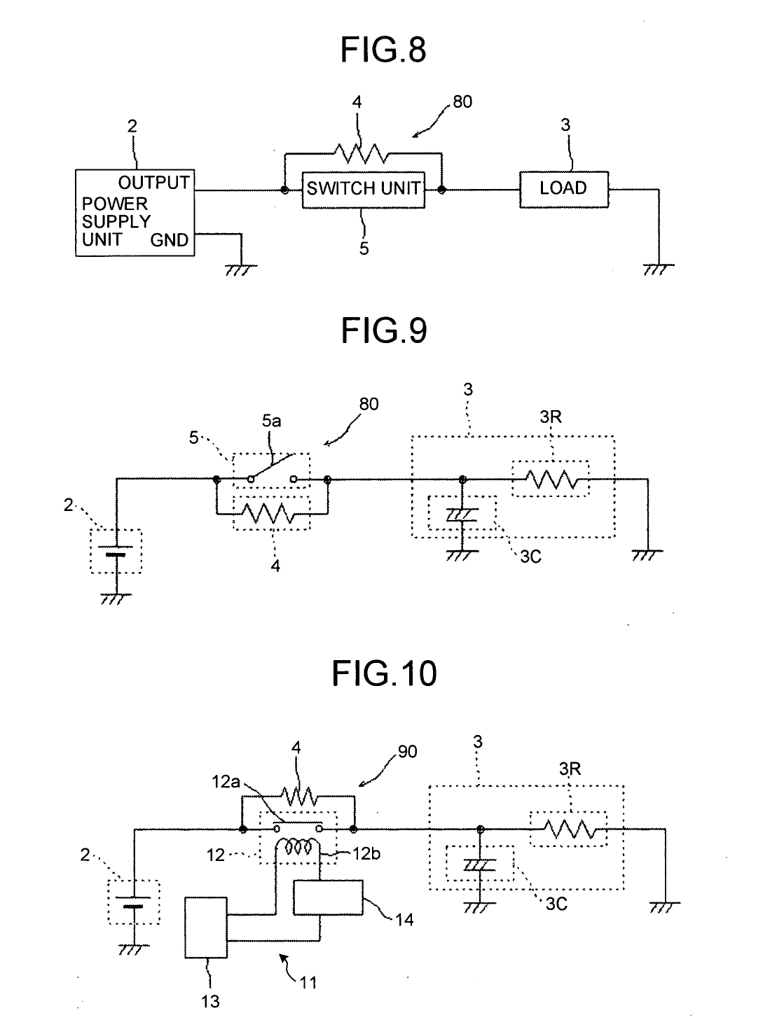

FIGS. 8 and 9 explain an interlock device 80 in Example 1 according to a second embodiment. FIG. 8 is a circuit block diagram of the interlock device 80 in Example 1.

The interlock device 80 is connected in series between the power supply unit 2 and the load 3 that is an operating unit. The interlock device 80 includes the resistor (bypass unit) 4 and the switch (power-supply control unit) 5 connected in parallel with the resistor 4. Typically, the load 3 is grounded. When the switch unit 5 of the interlock device 80 is on in the steady state, the steady current flows from the power supply unit 2 into the load 3 through the switch unit 5, thereby supplying a power to the load 3.

FIG. 9 represents the case where a DC power supply is used as the power supply unit 2, the microswitch unit 5a is used in the switch unit 5, and the load 3 includes the load resistance component 3R and the load capacitance component 3C. The resistor 4 has a predetermined resistance.

For example, the microswitch unit 5a is provided to an opening and closing unit, such as a door or a cover of a sheet discharge tray of an electric apparatus (e.g., facsimile and printer). The microswitch unit 5a performs on/off action being triggered by a mechanical on/off operation of the opening and closing unit.

The resistor 4 has a resistance that allows a low current for charging the load capacitance component 3C to flow at least when the microswitch unit 5a is off (open). Specifically, the resistor 4 has a resistance that allows minimum amount of charges for compensating a leak current from the load capacitance component 3C that is charged, so that a power consumed when the switch unit 5 is off can be reduced.

The load 3 is directly controlled by the switch unit 5, so that the load resistance component 3R has a constant resistance and allows some current to flow when the switch unit 5 is off. Therefore, the load capacitance component 3C is charged with the voltage divided by the resistor 4 and the load resistance component 3R. Thus, the amount of charges to be charged is smaller than that in the steady state after the switch unit 5 is turned on (close). However, the load capacitance component 3C is charged to some degree before the switch unit 5 is closed, so that the inrush current can be limited.

If the action of the load 3 is not directly controlled by the switch unit 5, the load resistance component 3R has extremely high resistance except when the switch unit 5 is on and an output control unit is on, so that little current flows into the load resistance component 3R. Thus, the load capacitance component 3C is charged by almost 100% power supply voltage. Accordingly, even just after the switch unit 5 is closed, the inrush current hardly flows.

While the switch unit 5 is off, the load capacitance component 3C is charged through the resistor 4. Therefore, the inrush current generated even just after the switch unit 5 is turned on can be limited and the load 3 cab be supplied with an appropriate power in the steady state (when the load 3 is operated).

Specifically, in the steady state, the microswitch unit 5a of the interlock device 80 is closed, and the steady current is supplied to the load 3 from the power supply unit 2.

In the steady state, both ends of the resistor 4 are short-circuited by the microswitch unit 5a, which is turned on, so that a desired steady current can be stably supplied to the load 3.

In the steady state, the microswitch unit 5a is turned off when the opening and closing unit of the electric apparatus is opened, thereby interrupting the supply of the steady current from the power supply unit 2 to the load 3. Thus, the electric apparatus becomes in the power-off state.

In the power-off state, because the resistor 4 is connected in parallel with the microswitch unit 5a, which is opened, a low current flows from the power supply unit 2 into the load capacitance component 3C through the resistor 4. Thus, the load capacitance component 3C is charged.

In the power-off state, when the opening and closing unit is closed, the microswitch unit 5a is turned on, and a power is supplied from the power supply unit 2 to the load 3 through the microswitch unit 5a. Because the load capacitance component 3C is charged to some degree or fully through the resistor 4 during the power-off state, the inrush current generated just after the microswitch unit 5a is turned on can be limited.

In the interlock device 80, the resistor 4 is connected in parallel with the switch unit 5. The resistor 4 allows a low current to flow from the power supply unit 2 into the load 3 while the power supply is stopped. The switch unit 5 performs on/off action being triggered by the mechanical on/off operation of the opening and closing unit, thereby controlling the power supply from the power supply unit 2 to the load 3.

Accordingly, it is possible to realize the interlock device with a simple configuration at low cost, which can properly limit the inrush current generated at the start of the power supply at low cost by charging the load capacitance component 3C while the power supply to the load 3 is stopped, thereby properly supplying a power to the load 3.

Because the interlock device 80 includes the microswitch unit 5a in the switch unit 5, it is possible to realize the interlock device with a simpler configuration at a lower cost, which can limit the inrush current generated at the start of the power supply, thereby supplying an appropriate power.

In Example 1 according to the second embodiment, the load 3 is grounded, and a current always flows into the load resistance component 3R of the load 3 through the microswitch unit 5a when the microswitch unit 5a is on in the steady state. Alternatively, the current flowing into the load resistance component 3R when the microswitch unit 5a is on can be controlled to be on/off (e.g., a circuit configuration can be employed in which the load 3 is not directly grounded).

FIG. 10 is a circuit diagram of an interlock device 90 in Example 2.

In Example 2, the components same as those of the interlock device 80 in Example 1 are given the same reference numerals, and the detailed explanation thereof is omitted.

The interlock device 90 is connected in series between the power supply unit 2 and the load 3 that is an operating unit. The interlock device 90 includes the resistor (bypass unit) 4 and the switch unit (power-supply control unit) 11 that is connected in parallel with the resistor 4.

The switch unit 11 includes the relay 12, the relay control unit 13, and the relay power supply unit 14. The relay 12 includes the relay contact 12a and the drive coil 12b. The relay contact 12a is connected in series in the power line between the power supply unit 2 and the load 3, and opens and closes the power line. The drive coil 12b drives the relay contact 12a to open and close the power line. The drive coil 12b is directly connected at one end to the relay power supply unit 14, and the other end thereof is connected to the relay power supply unit 14 through the relay control unit 13.

For example, when a sensor (not shown) detects an open/close operation of a door or a cover of a sheet discharge tray of the electric apparatus, or when a controller (not shown) detects power on/off of the electric apparatus, the sensor or the controller sends a detection signal to the relay control unit 13. The relay control unit 13 receives the detection signal, and then controls supplying of the drive current to the drive coil 12b from the relay power supply unit 14 according to the detection signal. The relay control unit 13 keeps the relay contact 12a turned on (close) while the drive current is supplied to the drive coil 12b, so that the steady current is supplied to the load 3 from the power supply unit 2. Whereas, the relay control unit 13 keeps the relay contact 12a turned off (open) while the supply of the drive current to the drive coil 12b is stopped, so that the steady current is stopped being supplied to the load 3 from the power supply unit 2.

In a similar manner to Example 1, the resistor 4 has a resistance that allows a low current for charging the load capacitance component 3C of the load 3 to flow when the relay contact 12a is off. Specifically, the resistor 4 has a resistance that allows minimum amount of charges for compensating a leak current from the charged load capacitance component 3C, so that a power consumed when the relay 12 is off can be reduced.

While the switch unit 11 is off, the load capacitance component 3C is charged through the resistor 4. Therefore, the inrush current generated just after the switch unit 11 is turned on can be limited, and the load 3 can be supplied with an appropriate current in the steady state (i.e., when the load 3 is operated).

Specifically, in the steady state, the relay control unit 13 of the switch unit 11 allows the drive current to flow from the relay power supply unit 14 into the drive coil 12b, closes the relay contact 12a, whereby the steady current is supplied to the load 3 from the power supply unit 2.

In the steady state, both ends of the resistor 4 are short-circuited by the relay contact 12a of the relay 12, so that a desired steady current can be stably supplied to the load 3.

In the steady state, when the relay control unit 13 receives a signal from the sensor indicating that the opening and closing unit is opened, or a power-off signal from the controller, the relay control unit 13 causes the relay power supply unit 14 to stop the supply of the drive current to the drive coil 12b. Therefore, the relay contact 12a is turned off, so that the supply of the steady current from the power supply unit 2 to the load 3 is interrupted. Thus, the electric apparatus becomes in the power-off state.

In the power-off state, because the resistor 4 is connected in parallel with the relay contact 12a that is opened, a low current flows from the power supply unit 2 into the load capacitance component 3C through the resistor 4. Thus, the load capacitance component 3C is charged.

In the power-off state, when the relay control unit 13 receives a signal, which is output by the sensor and indicates that the opening and closing unit is closed, or a power-on signal output from the controller, the relay control unit 13 causes the relay power supply unit 14 to supply the drive current to the drive coil 12b. Therefore, the relay contact 12a is turned on, and a power is supplied to the load 3 from the power supply unit 2 through the relay contact 12a. Because the load capacitance component 3C is charged to some degree or fully through the resistor 4 during the power-off state, the inrush current generated just after the relay contact 12a is turned on can be limited.

The interlock device 90 includes the relay 12 as the interlock switch, so that the load capacitance component 3C can be charged while power supply to the load 3 is stopped, with a simple configuration. Therefore, the inrush current can be properly limited at low cost at the time of starting the power supply, and a power can be properly supplied to the load 3.

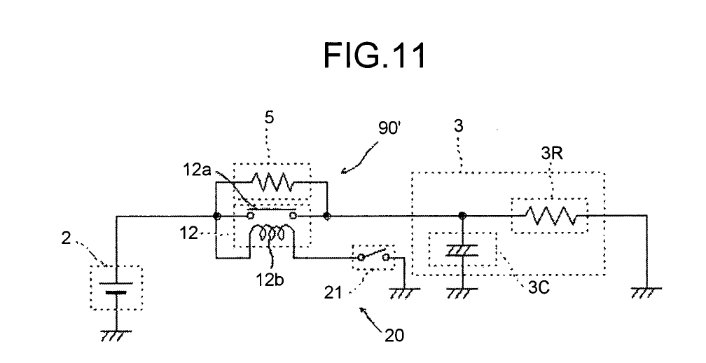

In Example 2, the switch unit 11 includes the relay power supply unit 14 as a dedicated power supply unit for driving the relay 12. However, the switch unit 11 may not include a dedicated power supply unit for driving the relay 12. For example, as shown in FIG. 11, the drive coil 12b can be connected to the power supply unit 2, and the switch 20 can utilize the power supply unit 2 for driving the relay 12.

FIG. 11 represents the case where the microswitch 21 of the switch 20 in an interlock device 90′ provided to the opening and closing unit of the electric apparatus serves as the relay control unit 13. When the opening and closing unit is closed in the interlock device 90′ shown in FIG. 11, the microswitch 21 is closed, and the drive current flows from the power supply unit 2 into the drive coil 12b, so that the relay contact 12a is turned on (close). Whereby, the steady current flows from the power supply unit 2 into the load 3. When the opening and closing unit is opened, the microswitch 21 is opened and the drive current output to the drive coil 12b is interrupted, so that the relay contact 12a is turned off (open).

Because the switch 20 of the interlock device 90′ does not include a dedicated power supply unit and a capacitive load, a large inrush current does not flow into the drive coil 12b at the instant of turning on the microswitch 21. Thus, parts with a low current rating can be used as the microswitch 21, so that the interlock device can be small in size and be manufactured at low cost.

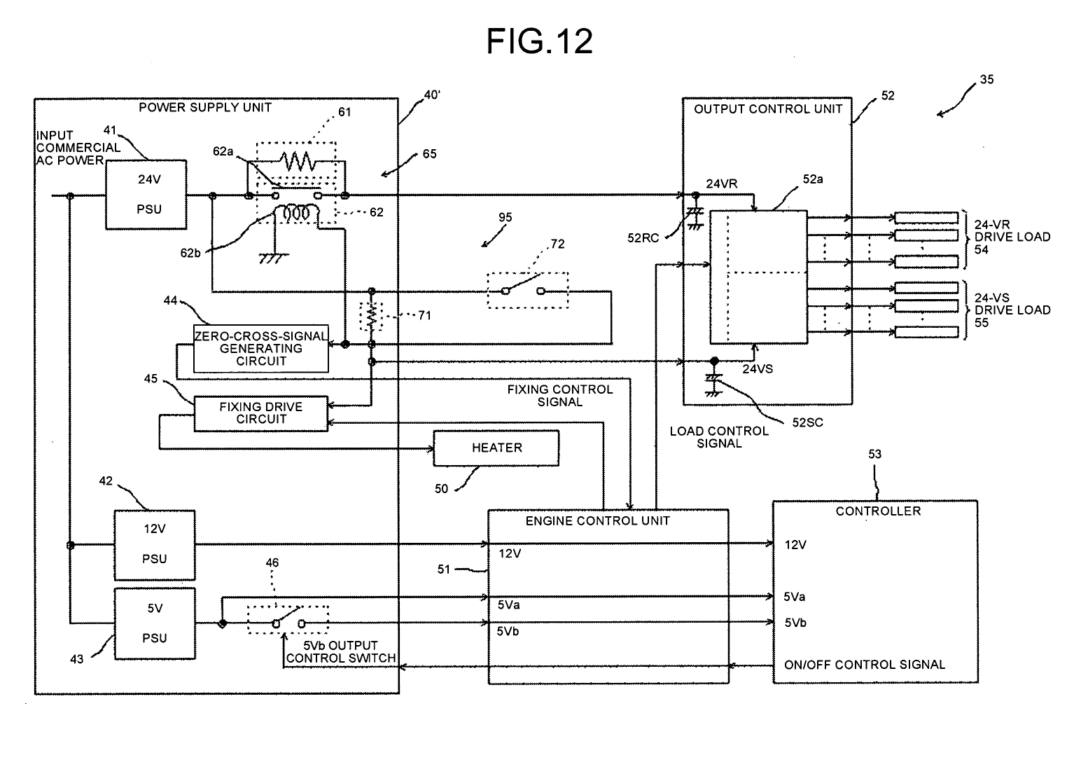

FIG. 12 is a block diagram of a relevant portion of an image forming apparatus 35 of Example 3 according to the second embodiment. The image forming apparatus 35 includes a power supply unit 40′, the heater (fixing heater) 50, the engine control unit 51, the output control unit 52, the controller 53, the 24-VR drive load 54, the 24-VS drive load 55, an interlock device 65, and an interlock device 95.

The power supply unit 40′ includes the PSUs 41 to 43 for supplying voltages of 24 V, 12 V, and 5 V, respectively, the zero-cross-signal generating circuit 44, the fixing drive circuit 45, and the 5-Vb output control switch 46. In addition, the power supply unit 40′ includes therein the resistor 61 and the relay 62 of the interlock device 65, and the resistor 71 of the interlock device 95.

A 100-V commercial AC power is input to each of the PSUs 41 to 43. The PSU 41 converts the 100-V commercial AC power into a 24-V DC power. Then, the PSU 41 supplies the 24-V DC power (24-VR power) to the output control unit 52 through the interlock device 65, and supplies the 24-V DC power (24-VS power) to the output control unit 52 through the interlock device 95. In addition, the PSU 41 supplies the 24-V power to the zero-cross-signal generating circuit 44 and the fixing drive circuit 45.

The PSU 42 converts the 100-V commercial AC power into a 12-V power, and supplies the 12-V power to the engine control unit 51. The PSU 43 converts the 100-V commercial AC power into a 5-V DC power. Then, the PSU 43 supplies the 5-V power (5-Va power) directly to a 5-Va terminal of the engine control unit 51, and supplies the 5-V power (5-Vb power) to a 5-Vb terminal of the engine control unit 51 through the 5-Vb output control switch 46.

The engine control unit 51 further outputs the 12-V power, which is output from the PSU 42, to the controller 53. The controller 53 uses the 12-V DC power mainly as a drive power for a hard disk. In addition, the engine control unit 51 further outputs the 5-Va power and the 5-Vb power, which are output from the PSU 43, to the controller 53. The controller 53 judges whether the 5-Vb output is necessary for a system. Specifically, the controller 53 judges that the 5-Vb output is necessary when the system is on standby or in operation, and that the 5-Vb output is not necessary when the system is in the power-off mode or in the sleep mode. After the judgment, the controller 53 outputs the on/off control signal for the 5-Vb output to the engine control unit 51. The engine control unit 51 receives the on/off control signal and outputs the on/off control signal to the 5-Vb output control switch 46, thereby controlling on/off of the 5-Vb output control switch 46.

The interlock device 65 includes the resistor (bypass unit) 61 and the relay (power-supply control unit) 62 that is connected in parallel with the resistor 61. The relay contact 62a of the relay 62 is connected in series between the PSU 41 and the output control unit 52. The drive coil 62b of the relay 62 is grounded at one end, and is connected to a contact point between the interlock device 95 and the zero-cross-signal generating circuit 44 at the other end.

The resistor 71 and the microswitch (power-supply control unit) 72 are connected in series in the interlock device 95. The microswitch 72 is provided to the opening and closing unit, such as a door or a sheet discharge tray, of the image forming apparatus 35. When the opening and closing unit is mechanically opened, the microswitch 72 is turned off (open). When the opening and closing unit is mechanically closed, the microswitch 72 is turned on (close).

Specifically, when the opening and closing unit of the image forming apparatus 35 is closed and the microswitch 72 is turned on, the steady current by the 24-V DC power from the PSU 41 is supplied to the zero-cross-signal generating circuit 44 and the fixing drive circuit 45 through the interlock device 95, and the drive current flows into the drive coil 62b of the interlock device 65.

Upon the flowing of the drive current into the drive coil 62b, the relay contact 62a is turned on (close), so that the PSU 41 is connected to the output control unit 52. Whereby, the steady current in the standby state is supplied by the 24-V DC power from the PSU 41 to the output control unit 52 through the resistor 61 as the 24-VR power.

The current supplied at this moment is the one supplied to the output control unit 52, which means that it is not the one supplied to the 24-VR drive load 54 and the 24-VS drive load 55 because the 24-VR drive load 54 and the 24-VS drive load 55 are not on-controlled by a signal from the engine control unit 51.

The zero-cross-signal generating circuit 44 outputs a zero cross signal to the engine control unit 51, and the engine control unit 51 recognizes a zero cross timing based on the zero cross signal and a turning-on condition of the heater in a fixing unit (not shown), and outputs the fixing control signal to the fixing drive circuit 45.

The fixing drive circuit 45 controls the drive current, which is output to the heater 50, based on the zero cross signal output from the zero-cross-signal generating circuit 44 and the fixing control signal output from the engine control unit 51, and controls heating of the heater 50. The heater 50 heats a heating roller (not shown) of the fixing unit. The heating roller heats and pressurizes a paper sheet being conveyed and having with a toner image transferred thereon in the electrophotographic system, thereby fixing the toner image onto the paper sheet.

The output control unit 52 includes the load control block unit 52a to which the 24-VS power and the 24-VR power are output from the PSU 41 of the power supply unit 40′. The load control block unit 52a includes capacitive components as a load, and the input units, to which the 24-VS power and the 24-VR power are input, respectively connected to the load capacitance component 52SC and the load capacitance component 52RC. A load control signal is input to the load control block unit 52a from the engine control unit 51. Based on the load control signal, a current flowing into the 24-VR drive load 54 and the 24-VS drive load 55 is controlled. The 24-VR drive-load 54 is driven by the 24-VR power, and the 24-VS drive load 55 is driven by the 24-VS power.

In the image forming apparatus 35, when the relay contact 62a is on, the PSU 41 supplies the 24-VR power for standby state to the output control unit 52 through the relay contact 62a. When the microswitch 72 is on, the PSU 41 supplies the 24-VS power supply for standby state to the output control unit 52 through the microswitch 72, and also supplies the 24-VS power for standby state to the zero-cross-signal generating circuit 44 and the fixing drive circuit 45.

In the standby state, when the opening and closing unit of the image forming apparatus 35 is opened, the microswitch 72 is turned off. Therefore, the supplying of the 24-VS power supply to the output control unit 52, the zero-cross-signal generating circuit 44, and the fixing drive circuit 45 is stopped. Whereby, the supply of the drive current to the drive coil 62b is stopped.

When the supply of the drive current to the drive coil 62b is stopped, the relay contact 62a is turned off (open), and the PSU 41 stops supplying the 24-VR power to the output control unit 52. Whereby, the image forming apparatus 35 becomes in a power-off state.

In the power-off state, the interlock device 65 allows a low current to flow from the PSU 41 into the load capacitance component 52RC through the resistor 61 to charge the load capacitance component 52RC. In addition, the interlock device 95 allows a Low current to flow from the PSU 41 into the load capacitance component 52SC through the resistor 71 to charge the load capacitance component 52SC.

Furthermore, in the power-off state, when the opening and closing unit is closed, the microswitch 72 is turned on. Then, the PSU 41 starts to supply the 24-VS power for standby state to the output control unit 52 through the microswitch 72, and supply the 24-VS power for standby state to the zero-cross-signal generating circuit 44 and the fixing drive circuit 45.

The load capacitance component 52SC is supplied with the charging current and is charged during the power-off state. Therefore, it is possible to limit an excessive inrush current that flows into the load capacitance component 52SC just after the microswitch 72 is turned on.

When the microswitch 72 is turned on, the drive current flows into the drive coil 62b, and the relay contact 62a is turned on. Thus, the PSU 41 starts to supply the 24-VR power to the output control unit 52 for standby state.

The current supplied at this moment is the one supplied to the output control unit 52, which means that it is not the one supplied to the 24-VR drive load 54 and the 24-VS drive load 55 because the 24-VR drive load 54 and the 24-VS drive load 55 are not on-controlled by a signal from the engine control unit 51.

The load capacitance component 52RC is supplied with the charging current through the resistor 61, and is almost fully charged during the power-off state. Therefore, it is possible to limit an excessive inrush current that flows into the load capacitance component 52RC (The inrush current hardly flows into the load capacitance component 52RC) just after the relay contact 62a is turned on.

Once the microswitch 72 or the relay 62 is turned on, all the low current, which is flowing through the resistor 71 or the resistor 61 during the power-off state, flows through the microswitch 72 or the relay 62. Therefore, the current flowing into the load does not decrease during operation or standby in the steady state.

In the image forming apparatus 35, the interlock device 65 and the interlock device 95 are provided between the PSU 41 and the load control block unit 52a (output control unit 52). Therefore, with a simple configuration at low cost, the load capacitance component 52RC and the load capacitance component 52SC can be charged while power supply to the load control block unit 52a is stopped, the inrush current generated at the time of starting the power supply can be properly limited at low cost, and the load 3 can be supplied with an appropriate power in the steady state.

This embodiment is explained by employing the image forming apparatus 35, such as a facsimile, a complex machine, and a printer. However, any electric apparatus that may cause an inrush current by turning on/off the power supply can be employed.

According to an aspect of the present invention, an excessive inrush current can be appropriately limited by a resistor at the start of the power supply, with a simple configuration at low cost, and an appropriate power can be supplied to an operating unit in the steady state by turning on a switch unit at the right timing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power-supply control device that controls a power supply from a power supply unit to an operating unit, comprising:
a power-supply control unit that is connected in series on a power line between the power supply unit and the operating unit, and that controls turning on/off of the power supply from the power supply unit to the operating unit;
a resistor having a predetermined resistance connected in series with the power-supply control unit;
a switch unit connected in parallel with the resistor; and
a switch control unit that detects turning on of the power supply from the power supply unit to the operating unit by the power-supply control unit, and turns on the switch unit in a predetermined waiting time after detecting the turning on of the power supply.

2. The power-supply control device according to claim 1, wherein
the switch control unit includes
a voltage dividing resistor that divides a voltage supplied to the operating unit through the power-supply control unit and the resistor, and
a transistor that is turned on/off based on a divided voltage obtained by the voltage dividing resistor, and
the switch unit is turned on by turning on the transistor.

3. The power-supply control device according to claim 2, wherein the switch control unit determines the predetermined waiting time based on a resistance of the voltage dividing resistor.

4. The power-supply control device according to claim 1, wherein the power-supply control unit is a microswitch.

5. The power-supply control device according to claim 1, wherein the power-supply control unit is a relay.

6. The power-supply control device according to claim 1, further comprising a bypass unit that is connected in parallel with the power-supply control unit, and that flows a predetermined current from the power supply unit into the operating unit while at least the power-supply control unit turns off the power supply.

7. An electric apparatus comprising:
a power supply unit that supplies a power;
an operating unit to which the power is supplied from the power supply unit; and
the power-supply control device according to claim 1 arranged between the power supply unit and the operating unit.

8. The electric apparatus according to claim 7, wherein the electric apparatus is an image forming apparatus that forms an image on a recording medium by a predetermined image forming method.

9. An interlock device for an electric apparatus, comprising:
an interlock switch that performs on/off operation in conjunction with a predetermined mechanical operation of the electric apparatus to control turning on/off of a power supply from a power supply unit to an operating unit;
a resistor having a predetermined resistance connected in series with the interlock switch;
a switch unit connected in parallel with the resistor; and
a switch control unit that detects turning on of the power supply from the power supply unit to the operating unit by the interlock switch, and turns on the switch unit in a predetermined waiting time after detecting the turning on of the power supply.

10. The interlock device according to claim 9, wherein
the switch control unit includes
a voltage dividing resistor that divides a voltage supplied to the operating unit through the power-supply control unit and the resistor, and
a transistor that is turned on/off based on a divided voltage obtained by the voltage dividing resistor, and
the switch unit is turned on by turning on the transistor.

11. The interlock device according to claim 10, wherein the switch control unit determines the predetermined waiting time based on a resistance of the voltage dividing resistor.

12. The interlock device according to claim 9, wherein the interlock switch is a microswitch.

13. The interlock device according to claim 9, wherein the interlock switch is a relay.

14. The interlock device according to claim 9, further comprising a bypass unit that is connected in parallel with the power-supply control unit, and that flows a predetermined current from the power supply unit into the operating unit while at least the interlock switch turns off the power supply.

15. An electric apparatus comprising:
a power supply unit that supplies a power;
an operating unit to which the power is supplied from the power supply unit; and
the interlock device according to claim 9 arranged between the power supply unit and the operating unit.

16. The electric apparatus according to claim 15, wherein the electric apparatus is an image forming apparatus that forms an image on a recording medium by a predetermined image forming method.
